(19) United States
(12) Patent Application Publication
(10) Pub. No.: US 2026/0010598 A1
(43) Pub. Date: Jan. 8, 2026

(54) SYSTEM AND METHOD FOR PERFORMING MISAPPROPRIATION DETECTION AND PREVENTION USING SIAMESE NEURAL NETWORKS

(71) Applicant: BANK OF AMERICA CORPORATION, Charlotte, NC (US)

(72) Inventors: Nimish Ravindra Deshpande, Mumbai (IN); Amit Chauhan, Gurugram (IN); Jai Issrani, Delhi (IN); Ashwrish Mehra, Gurugram (IN); Yash Misra, Lucknow (IN); Gaurav Sachdeva, New Delhi (IN); Sumit Sethi, New Delhi (IN); Shikha Verma, Gurugram (IN)

(73) Assignee: BANK OF AMERICA CORPORATION, Charlotte, NC (US)

(21) Appl. No.: 18/762,369

(22) Filed: Jul. 2, 2024

(51) Int. Cl. G06F 21/31

(52) U.S. Cl. CPC G06F 21/316

(57) ABSTRACT

Embodiments of the present invention provide a system for performing misappropriation detection and prevention using Siamese Neural Networks. The system is configured for identifying initiation of a resource interaction by a user, via an interaction device, determining if the resource interaction meets criteria associated with an unauthorized interaction based on applying a filtering mechanism, determining that the resource interaction meets the criteria associated with the unauthorized interaction and flag the resource interaction, passing the resource interaction to a Siamese Neural Network to determine if the resource interaction is unauthorized, and approving or denying the resource interaction based on determining if the resource interaction is unauthorized.

### BACKGROUND

There exists a need for a system for performing misappropriation detection and prevention using Siamese Neural Networks.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for performing misappropriation detection and prevention using Siamese Neural Networks. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies initiation of a resource interaction by a user, via an interaction device, determines if the resource interaction meets criteria associated with an unauthorized interaction based on applying a filtering mechanism, determines that the resource interaction meets the criteria associated with the unauthorized interaction and flag the resource interaction, passes the resource interaction to a Siamese Neural Network to determine if the resource interaction is unauthorized, and approves or denies the resource interaction based on determining if the resource interaction is unauthorized.

In some embodiments, the present invention in response to determining the initiation of the resource interaction, causes the interaction device to capture information associated with execution of the interaction.

In some embodiments, the present invention processes the information associated with the execution of the interaction to calculate one or more execution related values, extracts one or more patterns associated with the user from a data repository, extracts one or more previously established unauthorized patterns associated with historical unauthorized resource interactions, and passes the one or more execution related values, the one or more patterns, and the one or more established unauthorized patterns to the Siamese Neural Network along with the resource interaction.

In some embodiments, the present invention causes the Siamese Neural Network to process the one or more execution related values, the one or more patterns, and the one or more established unauthorized patterns to determine if the resource interaction is unauthorized.

In some embodiments, the one or more execution related values, the one or more patterns, and the one or more established unauthorized patterns are based on behavior data.

In some embodiments, the present invention trains the Siamese Neural Network with historical authorized resource interaction data, historical unauthorized resource interaction data, and established unauthorized pattern data.

In some embodiments, the filtering mechanism comprises one or more dynamically changing filters.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for performing misappropriation detection and prevention using Siamese Neural Networks, in accordance with an embodiment of the invention;

FIG. 2 provides a block diagram illustrating the entity system 200 of FIG. 1, in accordance with an embodiment of the invention;

FIG. 3 provides a block diagram illustrating a misappropriation detection and prevention system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for performing misappropriation detection and prevention using Siamese Neural Networks, in accordance with an embodiment of the invention; and

FIG. 6 provides a block diagram illustrating the process of performing misappropriation detection and prevention using Siamese Neural Networks, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be a financial institution which may include herein may include any financial institutions such as commercial banks, thrifts, federal and state savings banks, savings and loan associations, credit unions, investment companies, insurance companies and the like. As described herein, a “user” may be a customer or a potential customer of the entity.

A “resource interaction” or “resource distribution” or “transaction” or “interaction” refers to any communication between a user and third party entity (e.g., merchant) and/or a financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the “point-of-transaction device” (POT) or “point of interaction device” or “interaction device” may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, a “bank account,” a “resource pool,” or a “resource account” refers to a checking account, savings account, money market account, business account, foreign currency account, brokerage accounts, retirement accounts, health savings account, cash management accounts, custodial accounts, and/or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), entertainment device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Further, the term “payment credential,” or “payment vehicle,” or “resource credentials,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As described herein, a Siamese Neural Network may be employed by the system of the invention employed for performing one or more operations. Siamese Neural Network is an artificial neural network that uses the same weights while working in tandem on two different input vectors to compute comparable output vectors. In some embodiments, any other artificial neural networks may be employed by the system to perform the one or more operations. In some embodiments, a combination of Siamese Neural Network with any other artificial neural networks (e.g., Convolutional Neural Network) may be used to perform the one or more operations described herein.

With increase in technology, bad actors are finding new approaches to acquire resource credentials of users (e.g., credit card information) and perform unauthorized resource interactions using the misappropriated resource credentials. As such, these exists a need for a system that can perform detection and prevention of misappropriation attempts to perform unauthorized resource interactions. The system of the invention solves this problem as discussed in detail below.

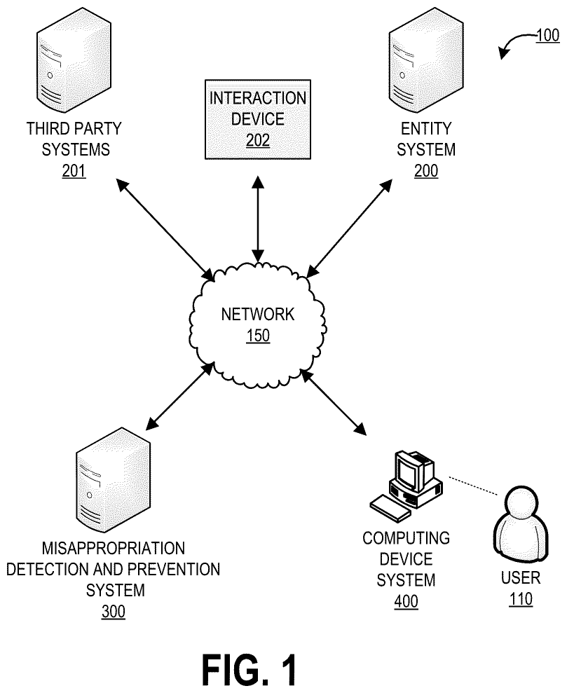

FIG. 1 provides a block diagram illustrating a system environment 100 for performing misappropriation detection and prevention using Siamese Neural Networks, in accordance with an embodiment of the invention. As illustrated in FIG. 1, the environment 100 includes a misappropriation detection and prevention system 300, an entity system 200, a computing device system 400, one or more third party systems 201, and one or more interaction devices 202. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200.

The entity system(s) 200 may be any system owned or otherwise controlled by an entity to support or perform one or more process steps described herein. In some embodiments, the entity is a financial institution. In some embodiments, the entity may be any organization that maintains one or more resource pools associated with the one or more users, where resources (e.g., funds) in the one or more resource pools may be used by the one or more users towards purchase of one or more goods, products, services, or the like provided by one or more third party entities (e.g., retail merchants, online retail merchants, or the like). The one or more third party systems 201 may be systems associated with the one or more third party entities. The one or more interaction devices 202 may be any devices that facilitates execution of resource interactions by users 110 at third party entity locations associated with the one or more third parties.

The misappropriation detection and prevention system 300 is a system of the present invention for performing one or more process steps described herein. In some embodiments, the misappropriation detection and prevention system 300 may be an independent system. In some embodiments, the misappropriation detection and prevention system 300 may be a part of the entity system 200. In some embodiments, the misappropriation detection and prevention system 300 may be controlled, owned, managed, and/or maintained by the entity associated with the entity system 200.

The misappropriation detection and prevention system 300, the entity system 200, the computing device system 400, and the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the misappropriation detection and prevention system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the misappropriation detection and prevention system 300, and/or entity system 200 across the network 150.

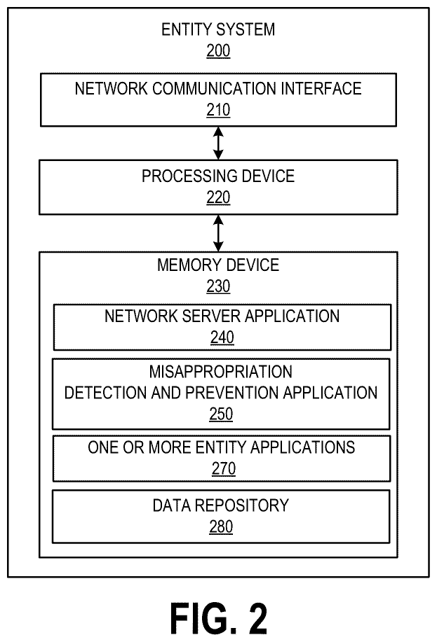

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a misappropriation detection and prevention application 250, one or more entity applications 270, and a data repository 280 comprising historical transaction data, historical product level data associated with one or more transactions performed by the users, and the like. The one or more entity applications 270 may be any applications developed, supported, maintained, utilized, and/or controlled by the entity. The computer-executable program code of the network server application 240, the misappropriation detection and prevention application 250, the one or more entity application 270 to perform certain logic, data-extraction, and data-storing functions of the entity system 200 described herein, as well as communication functions of the entity system 200.

The network server application 240, the misappropriation detection and prevention application 250, and the one or more entity applications 270 are configured to store data in the data repository 280 or to use the data stored in the data repository 280 when communicating through the network communication interface 210 with the misappropriation detection and prevention system 300, and/or the computing device system 400 to perform one or more process steps described herein. In some embodiments, the entity system 200 may receive instructions from the misappropriation detection and prevention system 300 via the misappropriation detection and prevention application 250 to perform certain operations. The misappropriation detection and prevention application 250 may be provided by the misappropriation detection and prevention system 300. The one or more entity applications 270 may be any of the applications used, created, modified, facilitated, developed, and/or managed by the entity system 200.

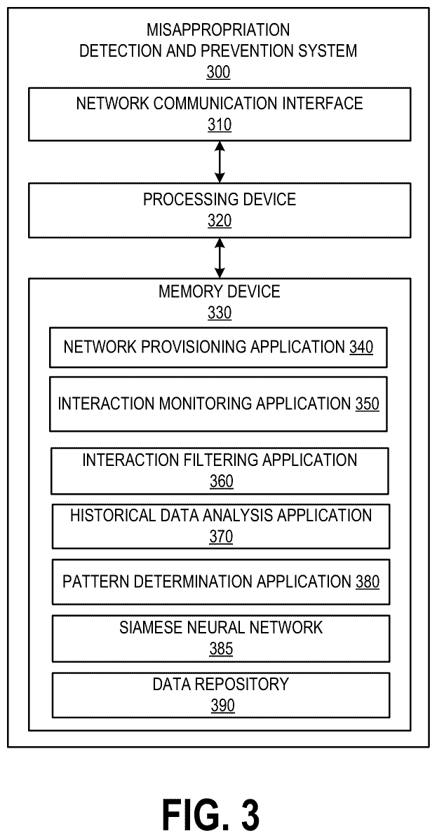

FIG. 3 provides a block diagram illustrating the misappropriation detection and prevention system 300 in greater detail, in accordance with embodiments of the invention. As illustrated in FIG. 3, in one embodiment of the invention, the misappropriation detection and prevention system 300 includes one or more processing devices 320 operatively coupled to a network communication interface 310 and a memory device 330. In certain embodiments, the misappropriation detection and prevention system 300 is operated by an entity, such as a financial institution. In some embodiments, the misappropriation detection and prevention system 300 is owned or operated by the entity of the entity system 200. In some embodiments, the misappropriation detection and prevention system 300 may be an independent system. In alternate embodiments, the misappropriation detection and prevention system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the misappropriation detection and prevention system 300 and to perform one or more processing functions described herein. For example, in one embodiment of the misappropriation detection and prevention system 300, the memory device 330 includes, but is not limited to, a network provisioning application 340, an interaction monitoring application 350, an interaction filtering application 360, a historical data analysis application 370, a pattern determination application 380, a Siamese Neural Network 385, and a data repository 390 comprising any data processed or accessed by one or more applications in the memory device 330. The computer-executable program code of the network provisioning application 340, the interaction monitoring application 350, the interaction filtering application 360, the historical data analysis application 370, the pattern determination application 380, and the Siamese Neural Network 385 may instruct the processing device 320 to perform certain logic, data-processing, and data-storing functions of the misappropriation detection and prevention system 300 described herein, as well as communication functions of the misappropriation detection and prevention system 300.

The network provisioning application 340, the interaction monitoring application 350, the interaction filtering application 360, the historical data analysis application 370, the pattern determination application 380, and the Siamese Neural Network 385 are configured to invoke or use the data in the data repository 390 when communicating through the network communication interface 310 with the entity system 200, and/or the computing device system 400. In some embodiments, the network provisioning application 340, the interaction monitoring application 350, the interaction filtering application 360, the historical data analysis application 370, the pattern determination application 380, and the Siamese Neural Network 385 may store the data extracted or received from the entity system 200, and the computing device system 400 in the data repository 390. In some embodiments, the network provisioning application 340, the interaction monitoring application 350, the interaction filtering application 360, the historical data analysis application 370, the pattern determination application 380, and the Siamese Neural Network 385 may be a part of a single application (e.g., modules).

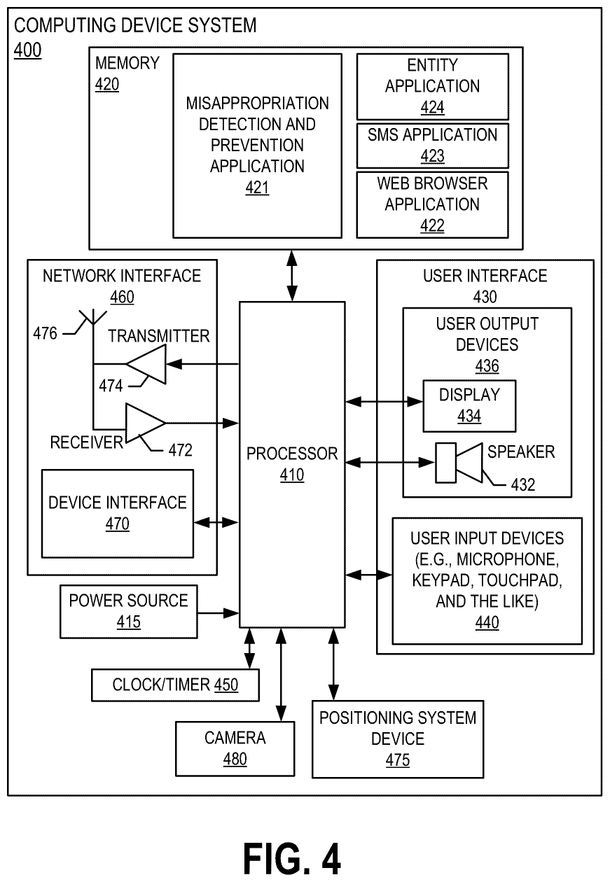

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a misappropriation detection and prevention application 421, entity application 424. These applications also typically instructions to a graphical user interface (GUI) on the display 430 that allows the user 110 to interact with the entity system 200, the misappropriation detection and prevention system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the misappropriation detection and prevention application 421 provided by the misappropriation detection and prevention system 300 allows the user 110 to access the misappropriation detection and prevention system 300. In some embodiments, the entity application 424 provided by the entity system 200 and the misappropriation detection and prevention application 421 allow the user 110 to access the functionalities provided by the misappropriation detection and prevention system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

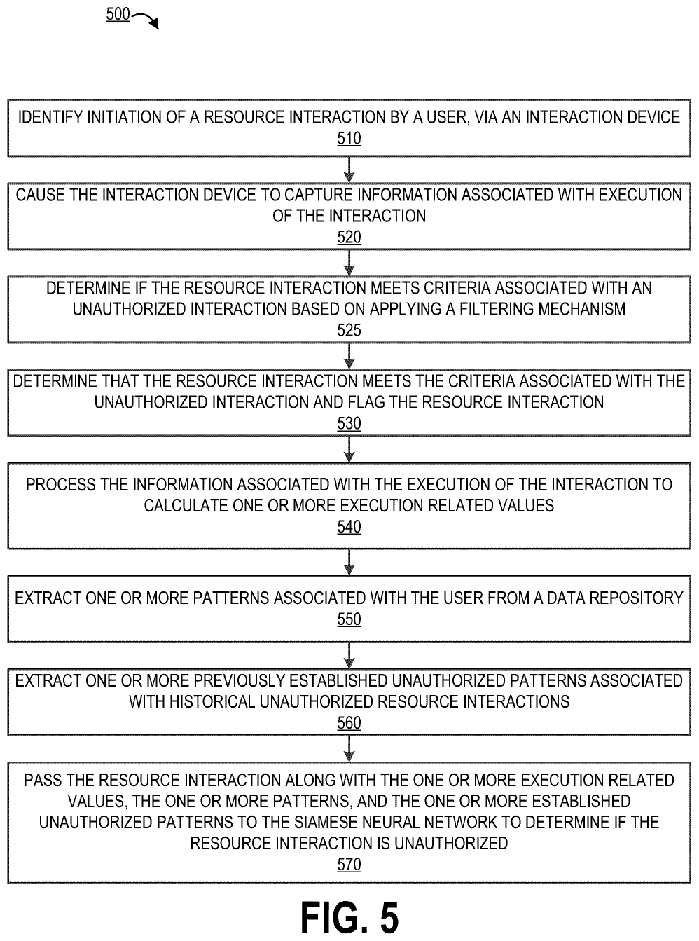

FIG. 5 provides a flowchart 500 illustrating a process flow for performing misappropriation detection and prevention using Siamese Neural Networks, in accordance with an embodiment of the invention. As shown in block 510, the system identifies initiation of a resource interaction by a user, via an interaction device. The system may continuously monitor one or more actions of the user (e.g., via a user device). For example, the system may continuously monitor user activity of the user via an application (e.g., entity application 424 or misappropriation detection and prevention application 421) installed on the user device after receiving permission from the user. Based on monitoring the activity of the user, the system may detect initiation of the resource interaction by the user. In some embodiments, the resource interaction is an online interaction, where the interaction device used to initiate the resource interaction is the user device (e.g., mobile phone, desktop, laptop, virtual reality device, augment reality device, and/or the like). In some embodiments, the resource interaction is an in-store interaction initiated at a third party entity location (e.g., merchant brick-and-mortar store) using resource vehicles (e.g., credit card, NFC enabled card, digital wallet, and/or the like), where the interaction device used to initiate the resource interaction may be a third party device (e.g., a Point of Transaction device).

As shown in block 520, the system causes the interaction device to capture information associated with execution of the interaction. In response to detecting initiation of the resource interaction, the system may cause the interaction device to capture information associated with the execution of the interaction. Information associated with the execution of the interaction may comprise any behavioral data, method of execution data (e.g., type of resource vehicle used, type of execution (e.g., contactless, chip, magstripe, and/or the like)), and/or the like. Behavioral data associated with the execution of the interaction may comprise typing speed of amount associated with the resource interaction, typing speed of authentication credentials (e.g., password), hand off timings between applications used for the resource interaction (e.g., time taken to switch between applications (such as a main screen to digital wallet) to perform the interaction), pattern of customers (e.g., is the user careful or casual while performing the resource interaction, where the patterns are calibrated based on length of life of user, where users above ‘X’ years may be more careful compared to users below ‘X’ years), and/or the like. In some embodiments, where the interaction device is a point of transaction device, the system may cause the point of transaction device to capture the behavioral data, method of execution data, and/or the like associated with the resource interaction.

As shown in block 525, the system determines if the resource interaction meets criteria associated with an unauthorized interaction based on applying a filtering mechanism. The filtering mechanism employed by the system may comprise one or more dynamically changing filters based on type of resource interaction (e.g., online, in-store, virtual, and/or the like). For example, the system may dynamically perform automatic selection of a first set of filters for an online transaction, a second set of filters for an in-store transaction, a third set of filters for a transaction initiated in a virtual reality environment, a fourth set of filters for a transaction initiated in an augmented reality environment. In some embodiments, the filtering mechanism employed by the system may be based on the method of execution of the resource interaction. In some embodiments, the filtering mechanism employed by the system may be based on the method of execution of the resource interaction and the type of resource interaction. Dynamically changing filters may comprise Internet Protocol (IP) address associated with the initiation of the resource interaction, trend associated with historical resource interactions (e.g., spend patterns), geolocation of the user, name of the user, resource credentials information (e.g., credit card CVV, expiry date, and/or the like) to associate and check type of resource credential used for the type of the resource interaction, time of initiation of the resource interaction, and/or the like.

As shown in block 530, the system determines that the resource interaction meets the criteria associated with the unauthorized interaction and flag the resource interaction. The system may apply the dynamic changing filters to the resource interaction to determine if the resource interaction is linked with any anomalies associated with the dynamically changing filters, where the anomalies are linked with the patterns associated with unauthorized interactions. For example, the system may determine that the IP address of initiation of the resource interactions is associated with previously flagged unauthorized interactions, the system may flag the resource interaction.

As shown in block 540, the system processes the information associated with the execution of the resource interaction to calculate one or more execution related values. In response to determining that the resource interaction meets the criteria associated with the unauthorized interaction, the system initiates processing of the information associated with the execution of the interaction to calculate one or more execution relation values. For example, the system may calculate typing speed of the user while providing authentication credentials associated with executing the resource interaction, time taken for switching between applications, etc.

As shown in block 550, the system extracts one or more patterns associated with the user from a data repository. The one or more patterns may comprise patterns associated historical data associated with the user. For example, the system may determine patterns based on analyzing 90 days of historical data comprising resource interaction data, activity data, and/or the like of the user and may store the patterns in the data repository.

As shown in block 560, the system extracts one or more previously established unauthorized patterns associated with historical unauthorized resource interactions. The one or more previously established patterns may be associated with known established suspicious behavior patterns exhibited by unauthorized user while performing unauthorized resource interactions. For example, the system may extract known suspicious behavior data such as errors while entering credentials, anomaly in typing speed, etc. associated with previously identified unauthorized resource interactions from the data repository of the system 300, external systems, or the entity system 200. In some embodiments, the one or more previously established patterns may be associated with historical unauthorized resource interactions determined by the system.

As shown in block 570, the system passes the resource interaction along with the one or more execution related values, the one or more patterns, and the one or more established unauthorized patterns to the Siamese Neural Network to determine if the resource interaction is unauthorized. The Siamese Neural Network takes the one or more execution related values, the one or more patterns, and the one or more established unauthorized patterns as inputs and generates a consensus associated with the determination of whether the resource interaction is unauthorized or not. For example, the Siamese Neural Network may process the inputs and may determine any deviations in the execution related values based on the one or more patterns and the one or more established unauthorized patterns to arrive at a consensus. In some embodiments, the system before initiation of this process, trains the Siamese Neural Network historical authorized resource interaction data, historical unauthorized resource interaction data, and established unauthorized pattern data.

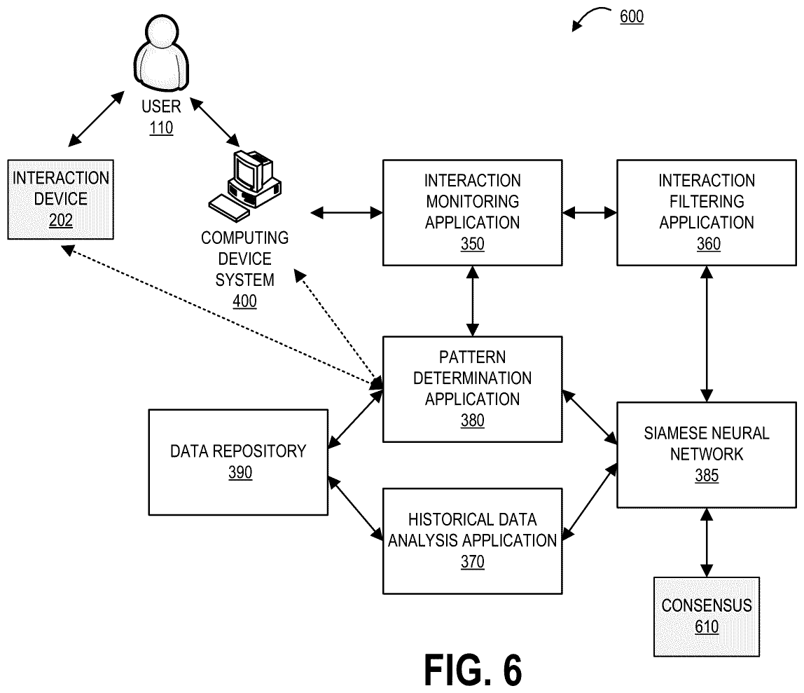

FIG. 6 provides a block diagram illustrating the process of performing misappropriation detection and prevention using Siamese Neural Networks, in accordance with an embodiment of the invention. As shown, the interaction monitoring application 350 monitors activity of the user to identify any resource interactions that are being initiated by the user. Based on monitoring the interaction monitoring application 350 may determine that the user 110 initiated the resource interaction with a computing device system 400 of the user 110 or the interaction device 202 (e.g., Point of Transaction device) and notifies the interaction filtering application 360. The interaction filtering application 360 may apply the filtering mechanism described above and determine whether to flag the resource interaction or not. The pattern determination application 380, upon identification of initiation of the resource interaction by the interaction monitoring application 350, may collect the information associated with the execution of the resource interaction. Upon applying the filtering mechanism, the interaction filtering application 360, in one embodiment, may flag the application for further review, and in another embodiment, may determine that resource interaction does not meet the criteria associated with the unauthorized resource interaction and may approve the resource interaction. In an embodiment, where the resource interaction is flagged by the interaction filtering application 360, the pattern determination application 380 may process the information collected during the execution of the resource interaction to calculate the one or more execution related values and the historical data analysis application 370 may determine historical patterns of the user for a predetermined amount of time period. The pattern determination application 380 and the historical data analysis application 370 may store the processed data in the data repository 390. In addition, the historical data analysis application 370 may also extract the one or more previously established unauthorized patterns associated with historical unauthorized resource interactions from the data repository 390. The pattern determination application 380 and the historical data analysis application 370 may then pass the one or more execution related values, the one or more historical patterns, and the one or more previously established unauthorized patterns to the Siamese Neural Network 385, where the Siamese Neural Network 385 consumes the inputs passed by the pattern determination application 380 and the historical data analysis application 370 to generate a consensus 610 that identifies whether the resource interaction is unauthorized or not.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent application:

| | U.S. patent | | |
|---|---|---|---|
| | application | | |
| Docket Number | Ser. No. | Title | Filed On |
| 15880US01.014033.5006 | To be | SYSTEM AND METHOD FOR | Concurrently |
| | assigned | PERFORMING RECOVERY OF | herewith |
| | | MISAPPROPRIATED INTERACTIONS | |
| | | VIA NEUROMORPHIC COMPUTING | |

1. A system for performing misappropriation detection and prevention using Siamese Neural Networks, the system comprising:
at least one network communication interface;
at least one non-transitory storage device; and
at least one processing device coupled to the at least one non-transitory storage device and the at least one network communication interface, wherein the at least one processing device is configured to:
identify initiation of a resource interaction by a user, via an interaction device;
determine if the resource interaction meets criteria associated with an unauthorized interaction based on applying a filtering mechanism;
determine that the resource interaction meets the criteria associated with the unauthorized interaction and flag the resource interaction;
pass the resource interaction to a Siamese Neural Network to determine if the resource interaction is unauthorized; and
approve or deny the resource interaction based on determining if the resource interaction is unauthorized.

2. The system of claim 1, wherein the at least one processing device is configured to in response to determining the initiation of the resource interaction, cause the interaction device to capture information associated with execution of the interaction.

3. The system of claim 2, wherein the at least one processing device is configured to:
process the information associated with the execution of the interaction to calculate one or more execution related values;
extract one or more patterns associated with the user from a data repository;
extract one or more previously established unauthorized patterns associated with historical unauthorized resource interactions; and
pass the one or more execution related values, the one or more patterns, and the one or more established unauthorized patterns to the Siamese Neural Network along with the resource interaction.

4. The system of claim 3, wherein the at least one processing device is configured to cause the Siamese Neural Network to process the one or more execution related values, the one or more patterns, and the one or more established unauthorized patterns to determine if the resource interaction is unauthorized.

5. The system of claim 3, wherein the one or more execution related values, the one or more patterns, and the one or more established unauthorized patterns are based on behavior data.

6. The system of claim 1, wherein the at least one processing device is configured to train the Siamese Neural Network with historical authorized resource interaction data, historical unauthorized resource interaction data, and established unauthorized pattern data.

7. The system of claim 1, wherein the filtering mechanism comprises one or more dynamically changing filters.

8. A computer program product for performing misappropriation detection and prevention using Siamese Neural Networks, the computer program product comprising a non-transitory computer-readable storage medium having computer executable instructions for causing a computer processor to perform the steps of:
identifying initiation of a resource interaction by a user, via an interaction device;
determining if the resource interaction meets criteria associated with an unauthorized interaction based on applying a filtering mechanism;
determining that the resource interaction meets the criteria associated with the unauthorized interaction and flag the resource interaction;
passing the resource interaction to a Siamese Neural Network to determine if the resource interaction is unauthorized; and
approving or denying the resource interaction based on determining if the resource interaction is unauthorized.

9. The computer program product of claim 8, wherein the computer executable instructions cause the computer processor to perform the step of in response to determining the initiation of the resource interaction, cause the interaction device to capture information associated with execution of the interaction.

10. The computer program product of claim 9, wherein the computer executable instructions cause the computer processor to perform the steps of:
processing the information associated with the execution of the interaction to calculate one or more execution related values;
extracting one or more patterns associated with the user from a data repository;
extracting one or more previously established unauthorized patterns associated with historical unauthorized resource interactions; and
passing the one or more execution related values, the one or more patterns, and the one or more established unauthorized patterns to the Siamese Neural Network along with the resource interaction.

11. The computer program product of claim 10, wherein the computer executable instructions cause the computer processor to perform the steps of causing the Siamese Neural Network to process the one or more execution related values, the one or more patterns, and the one or more established unauthorized patterns to determine if the resource interaction is unauthorized.

12. The computer program product of claim 10, wherein the one or more execution related values, the one or more patterns, and the one or more established unauthorized patterns are based on behavior data.

13. The computer program product of claim 8, wherein the computer executable instructions cause the computer processor to perform the step of training the Siamese Neural Network with historical authorized resource interaction data, historical unauthorized resource interaction data, and established unauthorized pattern data.

14. The computer program product of claim 8, wherein the filtering mechanism comprises one or more dynamically changing filters.

15. A computer implemented method for performing misappropriation detection and prevention using Siamese Neural Networks, wherein the method comprises:
identifying initiation of a resource interaction by a user, via an interaction device;
determining if the resource interaction meets criteria associated with an unauthorized interaction based on applying a filtering mechanism;
determining that the resource interaction meets the criteria associated with the unauthorized interaction and flag the resource interaction;
passing the resource interaction to a Siamese Neural Network to determine if the resource interaction is unauthorized; and
approving or denying the resource interaction based on determining if the resource interaction is unauthorized.

16. The computer implemented method of claim 15, wherein the method further comprises in response to determining the initiation of the resource interaction, cause the interaction device to capture information associated with execution of the interaction.

17. The computer implemented method of claim 16, wherein the method comprises:
processing the information associated with the execution of the interaction to calculate one or more execution related values;
extracting one or more patterns associated with the user from a data repository;
extracting one or more previously established unauthorized patterns associated with historical unauthorized resource interactions; and
passing the one or more execution related values, the one or more patterns, and the one or more established unauthorized patterns to the Siamese Neural Network along with the resource interaction.

18. The computer implemented method of claim 17, wherein the method comprises causing the Siamese Neural Network to process the one or more execution related values, the one or more patterns, and the one or more established unauthorized patterns to determine if the resource interaction is unauthorized.

19. The computer implemented method of claim 17, wherein the one or more execution related values, the one or more patterns, and the one or more established unauthorized patterns are based on behavior data.

20. The computer implemented method of claim 15, wherein the method comprises training the Siamese Neural Network with historical authorized resource interaction data, historical unauthorized resource interaction data, and established unauthorized pattern data.
